(19) United States
(12) Patent Application Publication
(10) Pub. No.: US 2006/0031296 A1
(43) Pub. Date: Feb. 9, 2006

(54) Method for distributing mail

(76) Inventor: Annika Wibeck, Ekero (SE)

Correspondence Address: Alfred J Mangels, 4729 Cornell Road, Cincinnati, OH, 45241-2433, US

(21) Appl. No.: 09/980,980

(22) PCT Filed: May 3, 2000
(86) PCT No.: PCT/SE00/00853

§ 371 Date: Sep. 12, 2002

(30) Foreign Application Priority Data
May 6, 1999 (SE) 9901644-6

(51) Int. Cl. G06F 15/16

(52) U.S. Cl. 709/206

(57) ABSTRACT

A method of sending mail electronically. A sender supplies information to a receiver on data media relative to mail to be sent, such as addressees and mail contents. The contents of the data media are fed into the receiver's computer system, in which the addressees are compared with a register that includes information as to whether or not respective addressees have an electronic mail address. The computer system sends the mail items by electronic mail to addressees that have an electronic mail address, and it sorts out as physical mail the mail to the remaining addressees to whom mail items are to be sent. Upon expiration of a predetermined time, the computer system sorts out such addressees who have not answered the electronic mail, for the purpose of sending them the mail item by physical mail.

### BACKGROUND OF THE INVENTION

1. Field of the Invention

The present invention relates to a method of sending mail, and more particularly to a method of sending mail electronically.

2. Description of the Related Art

It has become more usual to send mail to an addressee electronically. It would be particularly beneficial if bills and other printed matter were to be mailed by electronic mail. In this regard, a sender could deliver information concerning addresses and mail contents on data media to Posten Sverige AB (Swedish Post Office Department), which could then send the mail to respective addressees on the basis of its knowledge of their e-mail addresses.

One problem in this regard is whether or not the e-mail addresses of the addressees are known and whether or not the addressees wish to receive electronic mail.

Another important problem that arises when wishing to send bills or invoices, for instance to private individuals, via e-mail is that there is no way to check whether the addressee reads his/her e-mail regularly, makes payments by means of his/her personal computer, prints out bills or invoices when necessary, etc., as distinct from a physical letter sent by standard mail. It is assumed that a letter will be delivered to the addressee and that the addressee will open and read his/her mail.

These problems are solved by means of the present invention, which relates to a method of greatly facilitating the use of e-mail for sending mail of the kind which the addressee can be expected to answer.

### SUMMARY OF THE INVENTION

The present invention thus relates to a method of sending mail by electronic mail. A sender delivers information relating to the volume of mail to be sent, such as the addressees and contents of the mail, on data media to a receiver which is to send the mail to the addressees. The contents of said data media are fed into a computer system in which the addressees are compared with a register that includes information that discloses whether or not respective addressees have an electronic mail address. The computer system sends respective dispatches by electronic mail to addressees that have an electronic mail address, and it sorts out remaining addressees to whom mail is to be sent as physical mail. Subsequent to the passage of a predetermined period of time from the time at which electronic mail was sent but has still not been answered, the computer system sorts out such addressees and sends them a corresponding dispatch by physical mail.

### BRIEF DESCRIPTION OF THE DRAWING

The invention will now be described in more detail partly with reference to an exemplifying embodiment of the invention shown on the accompanying drawing, in which

FIG. 1 is a simple block diagram which illustrates a mailing method in accordance with the present invention.

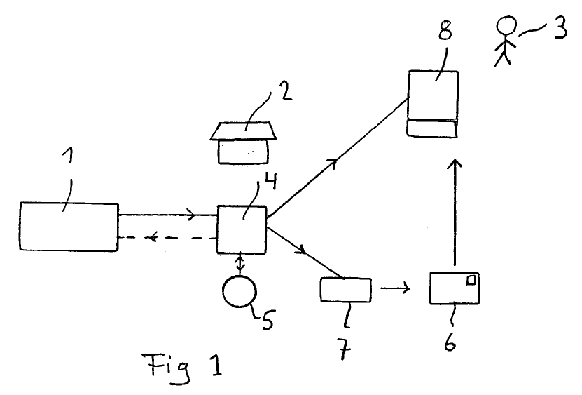

### DESCRIPTION OF THE PREFERRED EMBODIMENTS

The present invention relates to a method of sending dispatches by electronic mail. By electronic mail is meant so-called e-mail that is sent over the Internet or over some corresponding network. Different appropriate authorization codes may be included.

A sender 1 delivers information concerning the volume of mail to be sent, such as addressees and content, on data media to a receiver 2 that functions to send the mail to the addressees 3.

The sender may be a company that wishes to send bills or invoices to its customers, who then become the addressees. Naturally, the volume of mail may, instead, comprise different tenders, order confirmations, different types of document, such as partially completed declaration forms, etc. However, the invention is primarily useful to companies that wish to send an item of mail to a large number of addressees.

The invention is exemplified below with reference to a gasoline company [who] that wishes to bill companies and private individuals for the purchase of gasoline at filling stations by means of a credit card. It will be understood, however, that the invention is not limited to this area of use.

The gasoline company makes out at regular time intervals a number of bills that are to be sent to credit card owners for payment.

The sender 1, i.e., the gasoline company, sends information concerning the volume of mail, i.e., the bills to be sent, such as addressees and the contents of respective bills, on data media to the receiver 2 that is to send the mail to the addressees 3. The receiver may suitably be Posten Sverige AB.

According to the invention, the contents of said data media are entered into a computer system 4 belonging to the receiver. The addressees are compared with a register in the database 5 of the computer system that contains information as to whether respective addressees have an e-mail address. The database may also include information as to whether or not an addressee wishes to receive certain mail as e-mail and certain other mail as physical mail.

The computer system 4 is then caused to send the mail concerned by e-mail to those addressees that have an e-mail address. For instance, the e-mail is sent to the personal computer 8 of the addressee 3 via the Internet. The computer system 4 is also caused to sort out remaining addressees to whom the mail is to be sent as physical mail 6, this mail then passes through standard mail routines.

When physical mail is to be sent, the computer system 4 is caused to print out the dispatches by means of a printer 7.

According to the invention, when a predetermined period of time has passed from the time at which unanswered e-mail was first sent, the computer system 4 is caused to sort out such addressees and to send the corresponding e-mailed information as physical mail.

The physical mail is suitably sent as a mail item whose content corresponds to the content of the mail item sent by electronic mail. Instead, a bill or invoice reminder can be sent by physical mail.

By the word answered is meant that the addressee has been in contact with the sender within a predetermined time with regard to the mail item concerned. In the case of a bill, this contact will normally mean that payment is made. The sender informs the receiver that contact has been made or has not been made, after said predetermined time period has expired.

This is effected by causing the computer system 4 to receive from the sender information concerning those addressees who have answered their mail.

A large majority of the credit card owners is reached by first sending the mail item by electronic mail. Some of these credit card owners pay their respective bills within the allotted time period, whereas others do not. Those credit card owners who have not said that they are willing to receive electronic mail, are sent their bills or invoices conventionally by physical mail. Some of this latter group will also pay in time, whereas others do not.

The predetermined time period that shall have passed from when unanswered electronic mail was sent may, of course, vary depending on the type of mail concerned. In the case of bills or invoices issued by a gasoline company, an appropriate time may be when the standard payment term expires. In this case, the addressees are sent by physical mail a reminder that includes a copy of the bill. Similarly, the same kind of reminder can be sent to those who have already received the first mail item by physical mail.

Consequently, many mail items, namely the electronic mail items, are less expensive and simpler to send, and a reminder referring to unanswered or unpaid items will be sent automatically together with reminders to those who have not received electronic mail.

According to one highly preferred embodiment of the invention, the computer system 4 includes a database 5 which includes physical addresses and e-mail addresses of addressees who have expressed a wish to receive electronic mail.

Consequently, the anticipated response frequency to electronic mail will be much higher than when electronic mail addresses have been obtained from different sources.

The problems mentioned in the introduction are solved by the present invention.

Although the invention has been described above with reference to exemplifying embodiments thereof, it will be understood that the person skilled in this art will be able to modify the invention to accommodate different types of mail items. For instance, physical mail can be sent to an addressee who wishes to receive e-mail, after said addressee has been sent a reminder by e-mail.

The invention is therefore not limited to the aforedescribed embodiments thereof, since variations can be made within the scope of the accompanying claims.

What is claimed is:

1. A method of sending mail by means of electronic mail, wherein a sender supplies to a mailing receiver mailing information including addressees and mail contents for distribution of mail to the addressees, said method comprising the steps of: entering the mailing information into a computer system having a database that contains electronic mail addresses of addressees; transmitting the mail contents by electronic mail to addressees who have an electronic mail address and who have consented to receive electronic mail from the sender; sorting out for delivery as physical mail that mail intended for addressees who have not consented to receive electronic mail from the sender; and upon expiration of a predetermined time period from when electronic mail was sent sorting out addressees who have not responded to the electronic mail and sending them the mail contents by physical mail.

2. A method according, to claim 1, wherein the database includes physical addresses of the addressees.

3. A method according to claim 1, including the step of transmitting to the mailing information receiver information relating to those addressees who have answered their electronic mail.

4. A method according to claim 3, including the step of sending the mail contents by
